(19) United States
(12) Patent Application Publication
(10) Pub. No.: US 2003/0002676 A1
(43) Pub. Date: Jan. 2, 2003

(54) Method and apparatus to secure network communications

(76) Inventors: Thomas L. Stachura, Portland, OR (US); Nicholas A. Colman, Hillsboro, OR (US); Anil Vasudevan, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/895,788

(22) Filed: Jun. 29, 2001

(51) Int. Cl. H04L 9/00

(52) U.S. Cl. 380/260; 713/201; 709/229

(57) ABSTRACT

A method and apparatus for reestablishing secured communication after a desynchronization event. Secured communication is established between a first device and a second device using synchronized device dependent sequence values. A security sequence value from the first device is stored, preferably on a nonvolatile medium. After a desynchronization event, the first device sends the stored security sequence value to the second device as a resynchronization request. The second device returns the stored security sequence value as security assurance, preferably with a security sequence value from the second device for resynchronization.

### TECHNICAL FIELD

The present invention generally relates to the field of network communication systems and, more particularly, to a method and apparatus to synchronize network security sequence values.

### BACKGROUND

Network security schemes are not new. Indeed, a number of alternative schemes have been developed to improve the security of information for confidential communication over an otherwise public network, e.g., the Internet. Network security schemes may be used to secure a single communication path between two users, but may also be used to configure virtual private networks (VPNs). VPNs run over public facilities, but are effectively private because they use security techniques such as data scrambling that allow only secured members to access the data. VPNs avoid the cost of building a physical network or leasing private telecommunication lines. VPNs also allow members of a large organization to work as if onsite even though they may be at great distances from a work location.

An example of a network security scheme is the IP (Internet Protocol) security standardization effort, often referred to as IPsec, within the Internet Engineering Task Force (IETF). A general overview of IPsec is given in RFC 2401, “Security Architecture for the Internet Protocol,” November 1998. In general, IPsec provides authenticity/confidentiality guarantees for each data packet sent between network nodes that communicate using an implementation that conforms to an IPsec protocol. The data paths protected by IPsec security protocols may be those between hosts and security gateways on one or more network(s). A host may be a computing device, such as a server, client, base-station, or terminal. A security gateway is an intermediate system, such as a router or firewall. Collectively, network elements including computing devices, network servers, network routers, additional networks, base stations, user terminals, firewalls, routers, and/or security gateways may be referred to as nodes (“network nodes”).

IPsec offers protocols for security schemes such as anti-replay logic using security sequence values, and cryptographic key management. Anti-replay logic uses security sequence values to allow communicating devices to ignore data packets that have been previously received. This prevents computing devices that are outside a security connection from stealing confidential data by faking the IP address of another legitimate user on the secure connection (“spoofing”) and using exact duplicates of wiretapped data packets to fraudulently engage in the secured communication. Various other security implementations that conform to IPsec may also utilize security sequence values to prevent spoofing or to simply filter out expired data packets through a windowing scheme.

IPsec also mandates support for cryptographic key management and authentication algorithms. The authentication of the origin of a data packet is generally limited to the extent that secrets used with an authentication algorithm or key management protocol are shared among hosts that could each be the origin of the data packet. The secret authentication key(s) shared between communicating parties is typically a cryptographically strong random number. Lengths up to 128 bits must be supported by an implementation conforming to IPsec, but shorter and longer length keys are allowed. The key(s) are usually stored on a nonvolatile medium such as a hard drive or random access memory (RAM) that is nonvolatile.

When there is a break in secured communication, keys and other secret authentication information typically remain intact for the two or more parties that were securely communicating. Current sequence values used for anti-replay filtering and/or other security measures are typically lost, at least for the user having a power outage or other event that caused the break in secured communication. Even if recently used security sequence values are saved, a nondisrupted party may have sent additional data packets during the breakdown. This causes the disrupted party to lose track of current security sequence values being used by a nondisrupted party. Secured communication can be restarted through IPsec protocols that allow the regeneration and reauthentication of keys. However, this typically requires an active operating system (OS) and many microprocessor cycles. Thus, using a secured connection to troubleshoot the cause of a communication breakdown cannot easily be accomplished by known means since the breakdown must be repaired before secured communication can be reestablished.

### BRIEF DESCRIPTION OF THE DRAWINGS

The present invention is illustrated by way of example, and not by way of limitation, in the figures of the accompanying drawings in which like reference numerals refer to similar elements and in which:

FIG. 1 is a block diagram of an exemplary data network;

FIG. 2 is a block diagram of an exemplary client computing device incorporating an innovative security interface and showing a graphical representation of a machine accessible storage medium comprising a plurality of executable instructions including instructions which, when executed, implement one or more of the innovative security interface(s) and/or security agent(s).

FIG. 3 is a block diagram of a first embodiment of a an innovative security interface;

FIG. 4 is a block diagram of an exemplary server computing device incorporating a first embodiment of an innovative security agent;

FIG. 5 is a block diagram of a second embodiment;

FIG. 6 is a graphical illustration of an exemplary data structure comprising communication session security information and transmit sequence value information.

FIG. 7 is a block diagram of exemplary datagrams representing a synchronization message pair;

FIG. 8 is a flow chart of an exemplary method for securely synchronizing sequence values after a de-synchronizing event; and

FIG. 9 is a set of two communication flow diagrams illustrating an exemplary method for securing network communication between network elements.

### DETAILED DESCRIPTION

In a typical prior art data network, a server maintains a nonvolatile cache of security channel parameters, usually on a hard disk. The cached parameters may include security keys, such as those generated and authenticated by IPsec. Cached parameters may also include transmit and receive security sequence values for synchronizing the secured communication and performing anti-replay filtering. A client on the network may also cache security keys and transmit and receive security sequence values. When a power loss, low-power state, or other communication severing event occurs (“desynchronization event”), prior art networks running security protocols conforming to IPsec and other security protocols must rely on an active operating system and/or many cycles of an active microprocessor to regenerate and reauthenticate security keys and security sequence values.

The claimed invention is a simple and inexpensive method and apparatus to facilitate secure network communications, even at a low-power state or after a desynchronization event. In one embodiment, practiced in the context of an exemplary client-server network paradigm, an innovative network interface (“security interface”) is introduced into the client, while the server utilizes an innovative network agent (“security agent”) to facilitate the secured communications. The security interface is preferably rendered in hardware coupled to the low-power bus of the client to facilitate secure network communications for the host client when the client is in a low-power state. The security interface may maintain a sequence value that is utilized to authenticate secure communications between the client and another computing device (e.g., the server). A security sequence value is periodically stored by the security interface to a nonvolatile memory space or other low-power storage medium to enable a client to resynchronize a security sequence and reestablish the secured communication afforded by the use of sequence values after a desynchronizing event. Thus, a hardware implementation of a security interface may be capable of operating in the absence of an operating system and an active processor.

A security interface may optionally assume functions that are usually a part of security schemes conforming to IPsec. Specifically, a security interface may store security key(s) in addition to client security sequence values, preferably in a nonvolatile cache or medium. A security interface may increment client security sequence values and use the security sequence values for transmission of data packets to a server. Embodiments of the security interface may also perform anti-reply logic on data packets received from a server, however, the security sequence values received from the server need not be cached or stored in nonvolatile memory by the client. This is advantageous because it allows a client to request a secure connection using only its own resources.

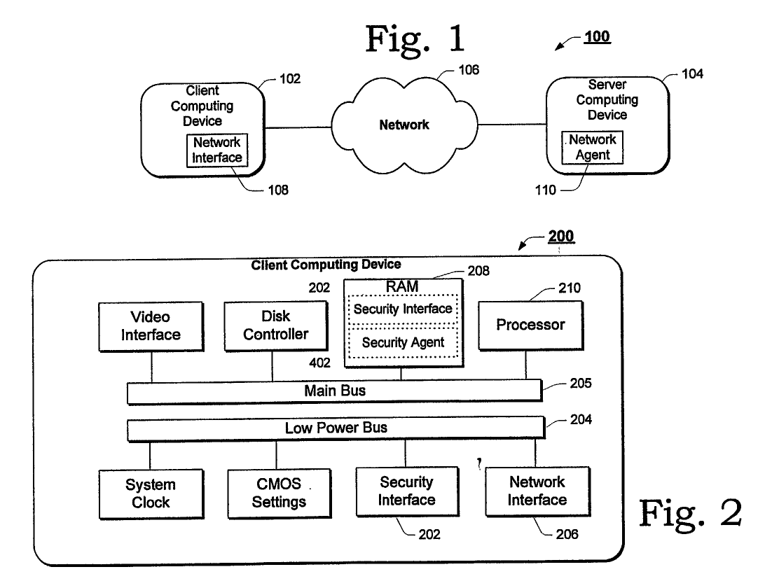

FIG. 1 is a block diagram of an exemplary data network. The computing network 100 of FIG. 1 depicts a client computing device 102 and a server computing device 104, although a security interface and/or a security agent may be used between any two or more network nodes. The shown client computing device 102 is coupled to a network interface 108 and the shown server computing device 104 is coupled to a network agent 110. A network interface 108 and a network agent 110, however, may be coupled to any network node. At least one network interface 108 and at least one network agent 110 preferably communicate over a network 106 such as an internet, extranet, wide area network (WAN), or local area network (LAN).

FIG. 2 shows one exemplary embodiment of a network node, shown as a client computing device 200, incorporating an innovative security interface 202 coupled to a bus. Although the shown exemplary security interface 202 is coupled to a low-power bus 204, other embodiments may be coupled to a main bus and still provide security features. A security interface 202 may reside as a substantially self-contained module, as discrete parts on a network interface module 206 (NIM), or as submodules disseminated at various useful locations in a network node. Alternate security interface 202 embodiments may optionally be implemented as at least one software security interface 203, or combinations of hardware and software. The shown modular security interface 202 may interact with many other components of the client computing device 200 including, but not limited to, NIM memory and/or network interface elements, and system memory 208.

Coupling a security interface 202 to a low-power bus 204 may allow wake-on LAN capability and other types of remote-control access to client network nodes. Security interfaces 202, 203 enhance manageability of a network by allowing a centralized service such as an information technology (IT) team to establish secured communication with distant network nodes even when the distant network nodes are in a low-power state. Secure access allows tasks such as rebooting, troubleshooting, updating of software, and debugging to be managed remotely even if the client is in a low-power state and lacking an OS and active processor 210.

In accordance with one example implementation, a machine accessible storage medium, shown graphically as an exemplary RAM 208 may comprise a plurality of executable instructions including instructions which, when executed, implement one or more of the innovative security interfaces 203, security agents 402, and/or methods of the present invention. Although pictured as integrated with a client, security interfaces 203 and security agents 402 may reside elsewhere as hardware or software, and no RAM may be required.

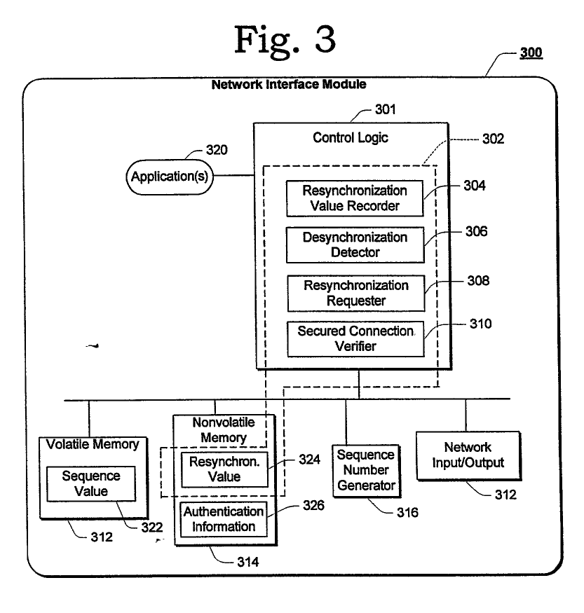

FIG. 3 shows an exemplary first embodiment of a security interface 302 incorporated into a NIM 300. Modules of the first embodiment include a recorder 304, a desynchronization detector 306, a resynchronization requester 308, and a secured connection verifier 310. Although the term “modules” is used to describe the elements of a security interface 302, the elements may be implemented as any combination of circuits, hardware units, programs, and/or software subroutines. A network interface 312 is used to engage in unsecured communication and in secured communication with at least one network. While described in terms of a network conforming to IPsec standards and synchronized security sequence values at least in part to authenticate secured communication, other security protocols and transfer protocols can be supported.

The control logic 301 of the NIM 300 incorporates the shown modules of the exemplary security interface 302. A recorder 304 preferably stores at least one client security sequence value as a client resynchronization value 324 in at least one machine-readable medium such as nonvolatile RAM 314, volatile RAM having power backup, flash memory having power backup, a magnetic disk storage medium, and/or an optical storage medium. Use in low-power states may require a machine-readable medium that is serviceable at low-power. Since embodiments of the security interface 302 are coupled to a low-power bus, the resynchronization value 324 stored in nonvolatile RAM 314 is retrievable in a low-power state.

A desynchronization detector 306 senses a desynchronization event, including but not limited to a low-power state, a no power state in some sectors of a network node, a halted microprocessor affecting communications, a fatal hardware error; a fatal software error, and/or a suspended network connection. The desychronization detector 306 preferably enables at least one other module of the security interface 302 to begin a resynchronization action after a desynchronization event.

A resynchronization requester 308 may be one module enabled by the desynchronization detector 306 to transfer a stored client resynchronization value 324 to a server or at least one other network node. In an embodiment adhering to IPsec standards, the resynchronization requester 308 may transfer the stored client resynchronization value 324 along with authentication keys mandated by IPsec. It should be noted that although keys are stored, the resynchronization requester 308 is not required to save security sequence values received from a server or other network node external to the client computing device. This provides simple and self-reliant recovery of secured communication without the need to track current security sequence values of external devices.

A security interface 302 may also have a secured connection verifier 310 to receive feedback from a server or other network node. Exemplary feedback preferably consists of the client resynchronization value 324 returned as security assurance and a server security sequence value from the server or network node. The feedback may also consist of public and private authentication keys if the communication adheres to IPsec. The returned client resynchronization value 324 and the server security sequence value provide resynchronization values for a client and server to each begin a new synchronized security sequences and resume bidirectional secured communication.

The client resynchronization value 324 sent by the security interface 302 to a server may function like a packet Internet groper (“ping”), but is sent to test the accessibility of a particular device on an IP network. The security interface 302 pings a server using a secured data packet containing previously established authentication keys and a client resynchronization value and waits for the server to echo a data packet containing the keys and the same client resynchronization value as security assurance. The echo preferably includes the received security information plus a new security sequence value from the server. Since the ping and echo preferably have new sequence values included when sent in each direction, identical data packets never appear on the network twice. The resulting data packet uniqueness afforded by the present invention prevents spoofing.

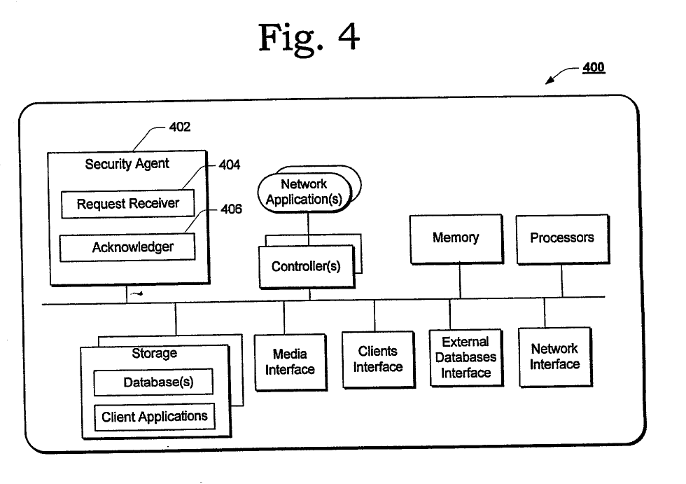

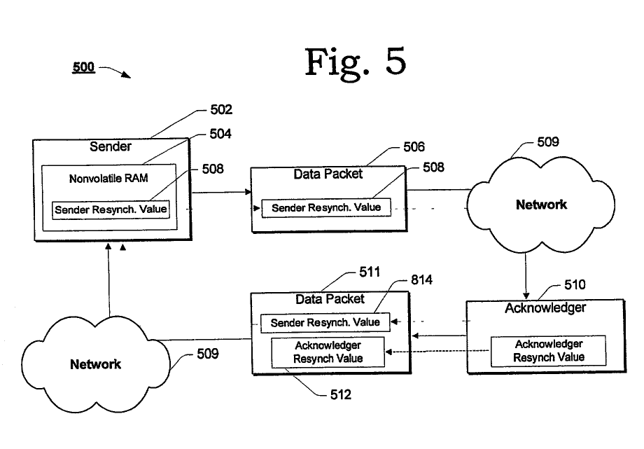

FIG. 4 shows an exemplary server 400 incorporating a first embodiment of a security agent 402. Although a security agent 402 may reside in a server 400 and return feedback to a client, a security agent 402 may also reside on any network node. A request receiver 404 module and an acknowledger 406 module may be included in a security agent 402. Although the term “module” is used to describe the elements of a security agent 402, the elements may be implemented as any combination of circuits, hardware units, programs, and/or software subroutines. A request receiver 404 recognizes a request for resynchronization from a security interface 302 of a client, and notifies an acknowledger 406 module to send feedback to the security interface 302. As discussed above, the feedback preferably includes a return of the client resynchronization value 324 sent by the security interface 302 along with a server security sequence value for reinitiating bidirectional secured communication. Authentication keys may be included in the feedback.

FIG. 5 shows a second embodiment of the claimed invention. A security sequence value resynchronizer 500 has a sender 502 having at least access to a nonvolatile random access memory 504. The sender 502 may possess or may at least have access to networking elements to transmit a first data packet 506 containing at least in part a stored sender resynchronization value 508 from the nonvolatile random access memory 504 over the computer network 509. An acknowledger 510 is preferably connected to the computer network 509 to receive the sender resynchronization value 508 from the sender 502. The acknowledger 510 has networking elements to return the sender resynchronization value 508 to the sender 502 as security assurance. The sender resynchronization value 508 is returned within the secured payload data of a second data packet 511. In one variation of the resynchronizer 500, the acknowledger 510 may return an acknowledger resynchronization value 512 to the sender 502 in addition to the sender resynchronization value 508.

Senders 502 may be installed as hardware and/or software on client computing devices, server computing devices, or any network node(s). Likewise, acknowledgers 510 may be installed as hardware and/or software on client computing devices, server computing devices, or any network node(s). In one embodiment, servers use software and clients use hardware embodiments capable of operation in a low-power state.

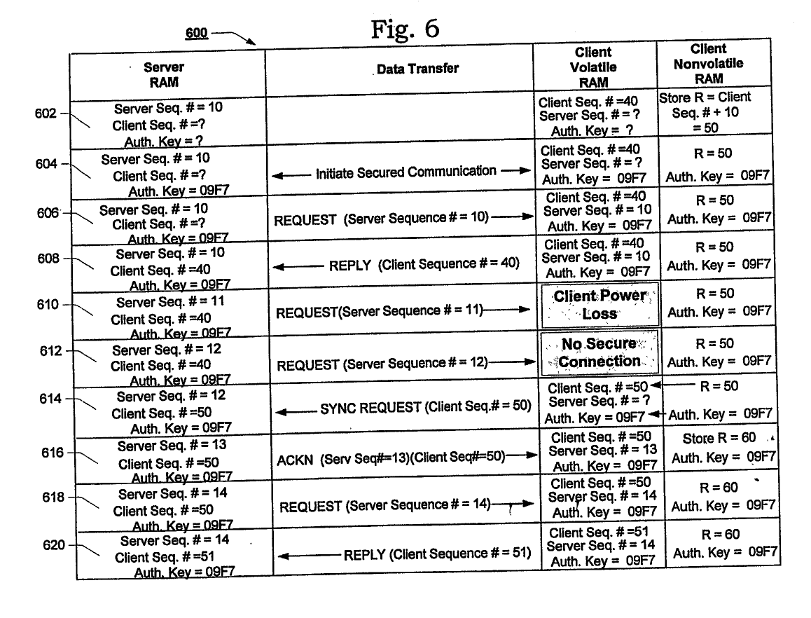

FIG. 6 shows example communication session information 600 residing in the RAMs of server and client devices. The shown RAMs are used to illustrate one preferred embodiment of the invention. The invention may also be practiced with registers or other variations that do not use RAM. Before secure communication is established 602, security secrets such as keys may not yet be shared, and security sequence values for secured communication may not yet be synchronized. An innovative security interface and/or method of the present invention stores a client security sequence value in nonvolatile RAM using an exemplary formula such as (current client security sequence value+10=50) as a resynchronization value should a desynchronization event occur. Secured communication may be initiated 604 using protocols such as IPsec by generating and sharing authentication keys 604. The server sends a request 606 using an exemplary server security sequence value of 10. The client replies 608 using a client security sequence value of 40. The server sends a second request 610 using an exemplary server security sequence value of 11, but the client has a power loss and is unable to receive the request. Security sequence values are desynchronized as the client loses track of incoming server requests. The server sends a third request using an exemplary security sequence value of 12, but the request is ignored because there is no secure connection. The innovative security interface, which may remain in a low-power state, restores the client resynchronization value and secrets such as security key(s) from nonvolatile RAM to volatile RAM 614 and updates the stored resynchronization value in nonvolatile RAM. The client resynchronization value restored to volatile RAM is sent as part of a synchronization request to the server. The server recognizes the client's authentication key(s) and acknowledges the client's synchronization request 616 by returning the client resynchronization value, preferably as part of a data payload, for security assurance. The server may also include a current server security sequence number in the acknowledgement. Server and client now possess all shared key(s) and security sequence numbers 618, and secured communication may resume. The server sends a request using an exemplary security sequence value of 14. The server replies 620 using an exemplary security sequence value of 51.

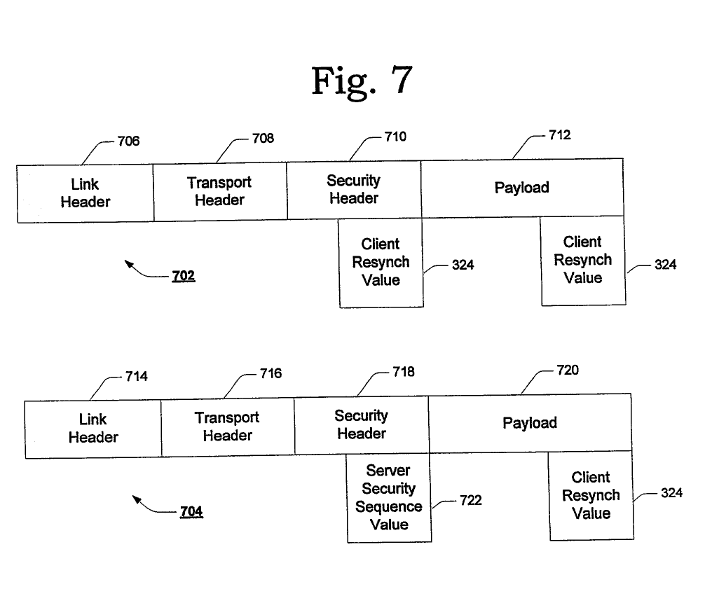

FIG. 7 shows exemplary data packets 700 representing a synchronous message pair. The SYNC_REQ packet 702 pings a server or other network node and a SYNC_ACK packet 704 is echoed by the server or other network node. A SYNC_REQ packet 702 may incorporate a link header 706, a transport header 708, a security header 710, and a data payload 712 in accordance with various IP protocols. A SYNC_ACK packet 704 may also incorporate a link header 714, a transport header 716, a security header 718, and a data payload 720 in accordance with IP protocol. In the SYNC_REQ packet 702, a client resynchronization value 324 is incorporated into the security header 710 and in the data payload 712. The data payload 720 of a corresponding SYNC_ACK packet 704 preferably incorporates the same client resynchronization value 324 sent by the security interface 302 of a client, but also preferably incorporates a server security sequence value 722 in the security header 718. Since the SYNC_REQ packet 702 and the SYNC_ACK packet 704 are unique, the same data packet does not appear on the Internet twice, preventing spoofing. The client resynchronization value 324 is preferably used to reinitiate a security sequence for the client, and the node security sequence value 722 is used to reinitiate or continue a security sequence for the server 400 or other network node.

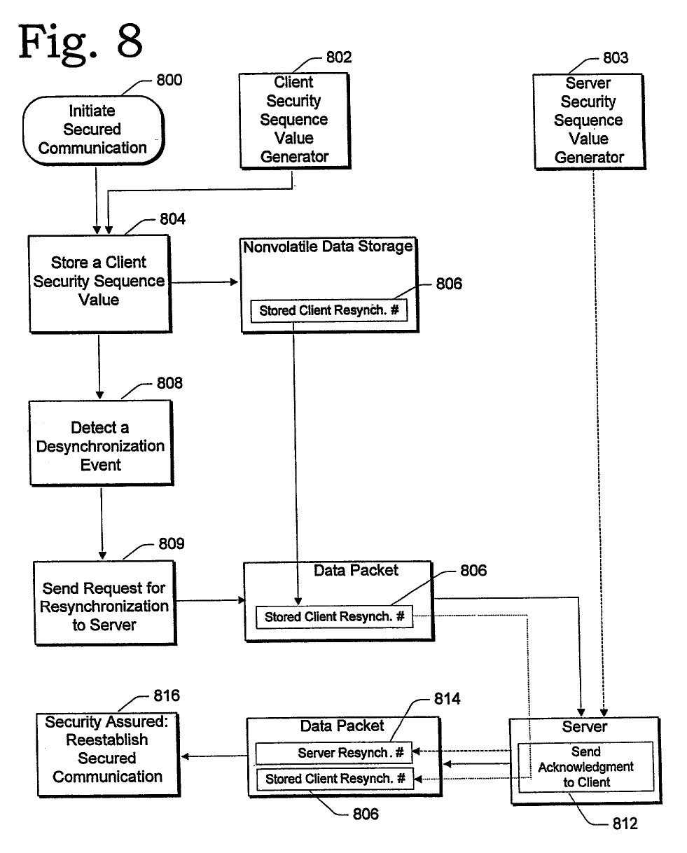

FIG. 8 shows an exemplary method of synchronizing security sequence values. Secured communication is established between a client computing device and a server computing device 800. The communication is secured using, at least in part, synchronized computing device dependent sequence values 802, 803. A security sequence value for the first computing device is stored 804 as a client resynchronization value 806. The resynchronization value 806 is preferably stored in a nonvolatile storage space, such as nonvolatile RAM. A desynchronizing event is detected 808. Resynchronization is requested 809 by sending the stored first resynchronization value 806 from the client computing device to the server computing device. The server computing device acknowledges 812 the request by sending the client resynchronization value 806 back to the client computing device as security assurance together with a server resynchronization value 814. When the client receives the acknowledgement, the client computing device and the server computing device both possess a client resynchronization value 806 and a server resynchronization value 814 and may reestablish secured communication 816.

Exemplary method embodiments of synchronizing security sequence values may be performed by hardware components, such as those shown in FIGS. 1-5, or a method may be embodied in machine-executable instructions, which may be used to cause a general-purpose or special-purpose processor or logic circuits programmed with the instructions to perform the steps. Alternatively, the steps may be performed by a combination of hardware and software. Thus, in one variation of a method embodiment, hardware and/or software may be installed in network nodes to perform the method. In another variation, security interface(s) and security agent(s) may be installed in both client and server computing devices to reestablish communication if both experience one or more desynchronization events.

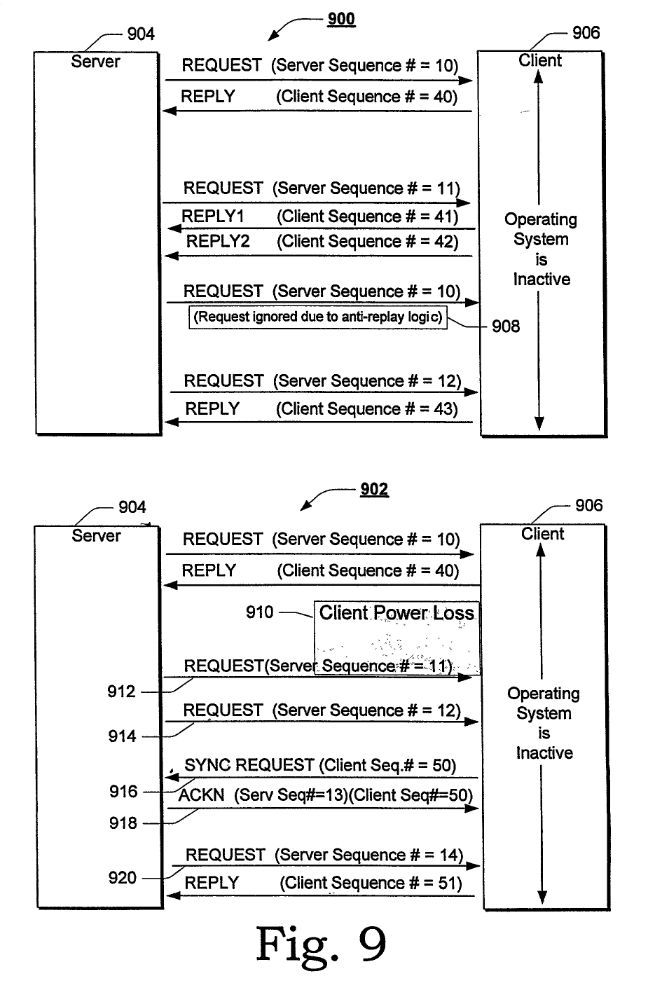

FIG. 9 compares a routine communication flow 900 between an exemplary server 904 and an exemplary client 906 with a disrupted communication flow 902 between the same server 904 and the same client 906, wherein the disrupted communication flow 902 is resynchronized by the present invention, such as the method shown in FIG. 8. In FIG. 9 the server 904 and client 906 may engage in secured communication even when the client lacks an active operating system and/or processor. The server 904 sends requests to the client 906, incorporating a server security sequence value that is incremented with each request. The client 906 replies, incorporating a client security sequence value that is incremented with each reply. The client 906 may use anti-replay logic to reject requests that have already appeared on the network 908.

A desynchronization event such as a client power loss 910 may occur, disrupting secured communication and preventing the client 906 from receiving a request 912 from the server 904. Because the secured connection is lost, the client 906 ignores unsecured request(s) 914. The client is safe from attacks through the channel of secure communication because the channel is inactive. The client 906 sends a synchronization request 916 incorporating a previously stored client resynchronization value. The server 904 acknowledges the request by returning the client resynchronization value 918 and by sending a current server security sequence value 918. The resynchronization method of the present invention cannot be spoofed because the request resynchronization data packet and the acknowledge data packet are unique. The secured connection may now be reestablished 920. Secured communication may now resume using the security sequence values exchanged by the server 904 and client 906 to resume security sequencing of data packets.

Optionally, client resynchronization values that are greater by a fixed interval than values recently used for real communication may be stored. In the shown example, the number 40 is the most recent real-time client security sequence value sent to the server 904 before a desynchronization event 910 occurred. The stored value to be used for resynchronization at the time of the desynchronization event 910 was the number 50. By storing resynchronization values incrementally higher than values at play in real time, servers may use dynamic windowing schemes to eliminate old or fraudulent data packets having security sequence values lower than a present window of values. Windowing schemes to destroy expired data packets that traverse the Internet seeking unattainable IP addresses are well known to persons having ordinary skill in the art.

A security sequence value resynchronizing method or apparatus may be provided partially or entirely as a computer program product which may include a machine-readable medium having stored thereon instructions which may be used to program a computer (or other electronic device(s)) to perform a process according to the present invention. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of media machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem or network connection).

Importantly, while the security sequence value resynchronizing method and apparatus have been described in the context of a computer network system, they can be applied to a wide variety of different systems in which data are exchanged. Such systems include voice, video, music, broadcast and other types of data systems. The method and apparatus can be applied to fixed remote terminals as well as to low and high mobility terminals. The method is described in its most basic form but additions and deletions could be made without departing from the basic scope. It will be apparent to those skilled in the art that many further modifications and adaptations can be made. The particular embodiments are not provided to limit the invention but to illustrate it. The scope of the present invention is not to be determined by the specific examples provided above but only by the claims below.

### Appendix A

William E. Alford, Reg. No. 37,764; Farzad E. Amini, Reg. No. 42,261; William Thomas Babbitt, Reg. No. 39,591; Carol F. Barry, Reg. No. 41,600; Jordan Michael Becker, Reg. No. 39,602; Lisa N. Benado, Reg. No. 39,995; Bradley J. Bereznak, Reg. No. 33,474; Michael A. Bernadicou, Reg. No. 35,934; Roger W. Blakely, Jr., Reg. No. 25,831; R. Alan Burnett, Reg. No. 46,149; Gregory D. Caldwell, Reg. No. 39,926; Andrew C. Chen, Reg. No. 43,544; Thomas M. Coester, Reg. No. 39,637; Donna Jo Coningsby, Reg. No. 41,684; Florin Corie, Reg. No. 46,244; Dennis M. deGuzman, Reg. No. 41,702; Stephen M. De Klerk, Reg. No. P46,503; Michael Anthony DeSanctis, Reg. No. 39,957; Daniel M. De Vos, Reg. No. 37,813; Justin M. Dillon, Reg. No. 42,486 ; Sanjeet Dutta, Reg. No. P46,145; Matthew C. Fagan, Reg. No. 37,542; Tarek N. Fahmi, Reg. No. 41,402; Mark W. Farrell, Reg. No. 45,988; George Fountain, Reg. No. 37,374; James Y. Go, Reg. No. 40,621; James A. Henry, Reg. No. 41,064; Willmore F. Holbrow III, Reg. No. P41,845; Sheryl Sue Holloway, Reg. No. 37,850; George W Hoover II, Reg. No. 32,992; Eric S. Hyman, Reg. No. 30,139; William W. Kidd, Reg. No. 31,772; Sang Hui Kim, Reg. No. 40,450; Walter T. Kim, Reg. No. 42,731; Eric T. King, Reg. No. 44,188; George B. Leavell, Reg. No. 45,436; Kurt P. Leyendecker, Reg. No. 42,799; Gordon R. Lindeen III, Reg. No. 33,192; Jan Carol Little, Reg. No. 41,181; Robert G. Litts, Reg. No. 46,876; Julio Loza, Reg. No. 47,758; Joseph Lutz, Reg. No. 43,765; Michael J. Mallie, Reg. No. 36,591; Andre L. Marais, under 37 C.F.R. §10.9(b); Paul A. Mendonsa, Reg. No. 42,879; Clive D. Menezes, Reg. No. 45,493; Chun M. Ng, Reg. No. 36,878; Thien T. Nguyen, Reg. No. 43,835; Thinh V. Nguyen, Reg. No. 42,034; Dennis A. Nicholls, Reg. No. 42,036; Daniel E. Ovanezian, Reg. No. 41,236; Kenneth B. Paley, Reg. No. 38,989; Gregg A. Peacock, Reg. No. 45,001; Marina Portnova, Reg. No. P45,750; Michael A. Proksch, Reg. No. 43,021; William F. Ryann, Reg. 44,313; James H. Salter, Reg. No. 35,668; William W. Schaal, Reg. No. 39,018; James C. Scheller, Reg. No. 31,195; Jeffrey S. Schubert, Reg. No. 43,098; George Simion, Reg. No. P47,089; Maria McCormack Sobrino, Reg. No. 31,639; Stanley W. Sokoloff, Reg. No. 25,128; Edwin H. Taylor, Reg. No. 25,129; Lance A. Termes, Reg. No. 43,184; John F. Travis, Reg. No. 43,203; Joseph A. Twarowski, Reg No. 42,191; Kerry D. Tweet, Reg. No. 45,959; Mark C. Van Ness, Reg. No. 39,865; Thomas A. Van Zandt, Reg. No. 43,219; Lester J. Vincent, Reg. No. 31,460; Glenn E. Von Tersch, Reg. No. 41,364; John Patrick Ward, Reg. No. 40,216; Mark L. Watson, Reg. No. P46,322; Thomas C. Webster, Reg. No. P46,154; and Norman Zafman, Reg. No. 26,250; my patent attorneys, and Firasat Ali, Reg. No. 45,715; Richard Nakashima, Reg. No. 42,023, my patent agents of BLAKELY, SOKOLOFF, TAYLOR & ZAFMAN LLP, with offices located at 12400 Wilshire Boulevard, 7th Floor, Los Angeles, Cali. 90025, telephone (310) 207-3800, and and Alan K. Aldous, Reg. No. 31,905; Robert D. Anderson, Reg. No. 33,826; Joseph R. Bond, Reg. No. 36,458; Richard C. Calderwood, Reg. No. 35,468; Jeffrey S. Draeger, Reg. No. 41,000; Cynthia Thomas Faatz, Reg No. 39,973; Sean Fitzgerald, Reg. No. 32,027; John F. Kacvinsky, Reg No. 40,040; Seth Z. Kalson, Reg. No. 40,670; David J. Kaplan, Reg. No. 41,105; Charles A. Mirho, Reg. No. 41,199; Leo V. Novakoski, Reg. No. 37,198; Naomi Obinata, Reg. No. 39,320; Thomas C. Reynolds, Reg. No. 32,488; Kenneth M. Seddon, Reg. No. 43,105; Mark Seeley, Reg. No. 32,299; Steven P. Skabrat, Reg. No. 36,279; Howard A. Skaist, Reg. No. 36,008; Steven C. Stewart, Reg. No. 33,555; Robert G. Winkle, Reg. No. 37,474; Steven D. Yates, Reg. No. 42,242, and Charles K. Young, Reg. No. 39,435; my patent attorneys, Thomas Raleigh Lane, Reg. No. 42,781; Calvin E. Wells; Reg. No. P43,256, Peter Lam, Reg. No. 44,855; Michael J. Nesheiwat, Reg. No. P47,819; and Gene I. Su, Reg. No. 45,140; my patent agents, of INTEL CORPORATION; and James R. Thein, Reg. No. 31,710, my patent attorney; with full power of substitution and revocation, to prosecute this application and to transact all business in the Patent and Trademark Office connected herewith.

What is claimed is:

1. A method comprising:
establishing secured communication between a client device and server device;
wherein communication is secured using, at least in part, synchronized security sequence value(s);
storing a security sequence value as a resynchronization value;
detecting at least one event desynchronizing said secured communication; and requesting resynchronization of security sequence values, comprising sending at least a representation of said resynchronization value from said client device to said server device.

2. The method of claim 1, further comprising performing anti-replay filtering using said security sequence values.

3. The method of claim 1, wherein sending at least a representation of said resynchronization value includes embedding said resynchronization value in at least one header and/or at least one payload of a data packet.

4. The method of claim 1, wherein said storing a client resynchronization value includes periodically refreshing a stored value with a new value at a selected interval from security sequence values already used in a secured communication session.

5. A method comprising:
establishing secured communication between a client device and server device;
wherein communication is secured using, at least in part, synchronized security sequence value(s);
acknowledging a client request for resynchronization, comprising sending at least a representation of said request for resynchronization and a server resynchronization value from said server device to said client device; and
reestablishing secured communication using said server resynchronization value.

6. The method of claim 5, wherein said client request for resynchronization is a client resynchronization value and said secured communication is reestablished using said client resynchronization value and said server resynchronization value.

7. The method of claim 6, wherein sending at least a representation of said client and said server resynchronization values includes embedding said client and said server resynchronization values in at least one header and/or at least one payload of a data packet that conforms to IPsec standards.

8. The method of claim 5, further comprising performing said method using a state machine in network circuitry.

9. The method of claim 5, further comprising using software to perform said method.

10. The method of claim 5, further comprising performing anti-replay filtering using said synchronized security sequence values.

11. The method of claim 5, further comprising reestablishing secured communication during a low-power state.

12. The method of claim 5, further comprising reestablishing secured communication while said first device lacks an active operating system and/or lacks an active microprocessor.

13. The method of claim 5, further comprising a machine-readable medium that provides instructions, which when executed by at least one electronic circuit, cause said at least one electronic circuit to perform operations comprising said method.

14. An apparatus, comprising;
(a) a security interface to engage in secured communication with at least one network node, wherein said security interface and said at least one network node use synchronized security sequence values at least in part to authenticate said secured communication;
(i) a recorder to store at least one security sequence value;
(ii) a desynchronization detector coupled to said security interface;
(iii) a resynchronization requester to send the stored security sequence value to at least one network node after a desynchronization; and
(iv) a verifier to receive feedback from said at least one network node;
(b) a security agent coupled to said at least one network node, comprising:
(i) a request receiver to recognize said stored security sequence value; and
(ii) an acknowledger to send said feedback from said security agent to said security interface; said feedback comprising said stored security sequence value and a node security sequence value from said network node.

15. The apparatus of claim 14, wherein stored security sequence values and node security sequence values are embedded in at least one header and/or at least one payload of a data packet that conforms to IPsec standards.

16. The apparatus of claim 14, wherein said stored security sequence value is periodically refreshed with a value at a selected interval from security sequence values already used in a secured communication session.

17. A computer network security sequence value resynchronizer, comprising:
(a) a sender having at least access to a nonvolatile random access memory;
(b) said sender to transmit a data packet containing at least in part a stored sender resynchronization value from said nonvolatile random access memory over said computer network; and
(c) an acknowledger connected to said computer network to receive said sender resynchronization value from said sender; said acknowledger returning said sender resynchronization value to said sender as security assurance.

18. The resynchronizer of claim 17, said acknowledger returning an acknowledger resynchronization value to said sender in addition to said sender resynchronization value.

19. The resynchronizer of claim 17, wherein at least one sender and at least one acknowledger are installed on any combination of server and client devices.

20. A method comprising:
establishing secured communication between a security interface and a network node, said security interface to resynchronize security sequence values between said security interface and said network node;
storing a first resynchronization value selected by said security interface; and resynchronizing said security sequence values after a break in said secured communication, said resynchronizing further comprising:
sending said first resynchronization value from said security interface to said network node;
sending said first resynchronization value and a second resynchronization value from said network node to said security interface; and
reestablishing said secured communication using said first resynchronization value and said second resynchronization value.

21. The method of claim 20 further comprising using a security interface as a state machine in network circuitry.

22. The method of claim 20 further comprising using a security interface as a software program.

23. The method of claim 20 further comprising storing said first resynchronization value in a nonvolatile storage medium.

24. The method of claim 20 further comprising establishing secured communication using IPsec security standards.

25. The method of claim 20 further comprising resynchronizing said secured communication using said first resynchronization value to resynchronize secured data sent from said security interface and using said second resynchronization value to resychronize secured data sent from said network node.

26. The method of claim 20 further comprising resynchronizing secured communication during a low-power state.

27. The method of claim 20 further comprising resynchronizing secured communication while said network node lacks an active operating system and/or lacks an active microprocessor.

28. A method, comprising:
establishing secured communication between a server device and a client device, said secured communication using server security sequence values synchronized with client security sequence values;
storing at least one client security sequence value in nonvolatile memory as a saved client security sequence value; and
resynchronizing server and client security sequence values after a desynchronization event by sending said saved client security sequence value from said nonvolatile memory to said server device.

29. The method of claim 28, said resynchronizing further comprising returning said saved client security sequence value from said server device to said client device in a data packet with a server security sequence value.

30. The method of claim 28, said storing further comprising periodically refreshing said saved client security sequence value with a number that is greater in value than client security sequence values that have already been sent to said server device in a communication session.
